(19) United States
(12) Patent Application Publication
(10) Pub. No.: US 2023/0213616 A1
(43) Pub. Date: Jul. 6, 2023

(54) SYSTEM AND METHOD FOR AUTOMATICALLY HARMONIZING THE POSITION AND/OR ORIENTATION BETWEEN AN APPARATUS ON BOARD A MOBILE CARRIER AND A REFERENCE FRAME OF THE MOBILE CARRIER

(71) Applicant: THALES, COURBEVOIE (FR)

(72) Inventors: Yoan VEYRAC, Merignac (FR); Richard MONTIGNY, Merignac (FR); Rodolphe COTTRON, Merignac (FR)

(21) Appl. No.: 17/777,870

(22) PCT Filed: Nov. 26, 2020
(86) PCT No.: PCT/EP2020/083519

§ 371 Date: May 18, 2022

(30) Foreign Application Priority Data
Nov. 28, 2019 (FR) FR1913375

(51) Int. Cl. G01S 7/40

(52) U.S. Cl. CPC G01S 7/4026

(57) ABSTRACT

The invention relates to a system and a method for automatically harmonizing the position and/or orientation between an apparatus on board a mobile carrier and a reference frame of said mobile carrier, said mobile carrier being provided with an inertial unit able to provide measurements in the reference frame. The system comprises:
at least one accelerometer mechanically coupled to the onboard apparatus, and providing acceleration measurements in a reference frame referred to as the associated onboard apparatus,
a reception unit configured to receive measurements provided by said inertial unit and measurements provided by the accelerometer,
a computing unit configured to calculate values of parameters defining a geometric transformation for conversion of data from the reference frame of the carrier and the reference frame of the onboard apparatus, from the measurements, carried out for at least two different flight orientations, by said inertial unit and by said accelerometer.

### CROSS-REFERENCE TO RELATED APPLICATIONS

The present Application for Patent is a National Stage Entry of International Application No. PCT/EP2020/083519, filed Nov. 26, 2020, which claims priority to French Patent Application No. 19 13375, filed Nov. 28, 2019. The disclosures of the priority applications are incorporated in their entirety by reference therein.

### FIELD OF THE INVENTION

The present invention relates to a system and a method for automatically harmonizing the position and/or orientation between an apparatus on board a mobile carrier and a reference frame of said mobile carrier, for example an aircraft.

The invention is in the field of the use of onboard apparatus on mobile carriers and finds a particular application in the field of airborne radar systems.

### BACKGROUND OF THE INVENTION

In this field, it is necessary to know the precise orientation of the sighting axis of the onboard radar system relative to a reference frame of the mobile carrier, on the one hand to perform processing and to compensate for the movements of the carrier in the radar system, and on the other hand to display correctly the output data of the radar system relative to the mobile carrier.

For example, radar systems including one or more antenna panels, fixed in a distributed manner at several locations of the carrier, are used. The mobile carrier is for example an airplane, a helicopter or a drone.

Conventionally, it is possible to perform a precise mechanical calibration, using centering pins or dedicated wedges, to fix, in a known way, the position and orientation of the or each antenna panel relative to the carrier. Nevertheless, such an operation requires mechanical parts and precise assembly, and is not suitable for use in which the onboard systems are regularly disassembled/reassembled, for example for maintenance or according to the different missions to be carried out by the mobile carrier.

It is also known to perform an installation with less mechanical fixing accuracy, but to obtain an accurate measurement of the positioning of the onboard apparatus, or of each antenna panel of the onboard apparatus in the case of a radar system with multiple antenna panels. Such an accurate measurement is then used to perform digital compensation in the radar system.

For example, methods are known that use the acquisition of multiple images or multiple targets (or sights) by the radar system, and the application of digital processing to calculate the position and/or orientation of the onboard system in a reference frame of the carrier that is, for example, provided by a carrier inertial unit. Such methods have the advantage of providing results automatically, but are dependent on the environment of the carrier, and do not provide satisfactory results in all circumstances. For example, when optical sights are used, it is necessary to carry out measurements on the ground, in a harmonization procedure, which is particularly tedious in the case of disassembly and reassembly of the radar systems on a mobile carrier.

### SUMMARY OF THE INVENTION

The object of the invention is to remedy the disadvantages of the state of the art, and to provide a method and a system for automatically harmonizing the position and/or orientation between apparatus on board a mobile carrier and a reference frame of said mobile carrier able to operate independently of the environment of the carrier.

To this end, the invention proposes an automatic system of position and/or orientation between an apparatus on board a mobile carrier and a reference frame of said mobile carrier, said mobile carrier being equipped with an inertial unit able to provide measurements of acceleration and angular velocity of rotation of said mobile carrier in said reference frame. This system includes:
at least one accelerometer mechanically coupled to the onboard apparatus, and providing acceleration measurements in a reference frame referred to as the associated onboard apparatus,
a reception unit configured to receive measurements provided by said inertial unit and measurements provided by the accelerometer,
a computing unit configured to calculate values of parameters defining a geometric transformation for conversion of data between the reference frame of the carrier and the reference frame of the onboard apparatus, from said measurements, carried out for at least two different flight orientations, by said inertial unit and by said accelerometer.

Advantageously, the system for automatically harmonizing the position and/or orientation between an apparatus on board a mobile carrier and a reference frame of the mobile carrier implements calculations on measurements made, on the one hand, by the inertial unit on board the carrier, and, on the other hand, by the accelerometer or accelerometers fixed to the onboard apparatus, without requiring other measurements or adjustments.

The automatic harmonization system according to the invention may also have one or more of the following features, taken independently or in any technically conceivable combination:

The accelerometer is an accelerometer able to provide acceleration measurements according to three spatial axes.

The mobile carrier is an aircraft, the onboard apparatus is a radar system including at least one antenna panel, the or each antenna panel having an associated phase center, and including an accelerometer mechanically coupled to the antenna panel and having a reference frame centered on said phase center.

The geometric transformation for conversion of data comprises a rotation and a translation, the rotation being defined by three rotation angles and the translation being defined by a translation vector.

The calculation of parameter values is performed by digitally solving a system of equations implementing a rotation matrix defining said rotation and said translation vector.

According to another aspect, the invention relates to a method for automatically harmonizing the position and/or orientation between an apparatus on board a mobile carrier and a reference frame of the mobile carrier, implemented by a harmonization system as briefly described above, and including steps, for at least two flight maneuvers corresponding to two different flight orientations of:
receiving and storing inertial data obtained from measurements provided by the inertial unit in a reference frame of the inertial unit;
receiving and storing of acceleration data obtained from measurements provided by an accelerometer in a reference frame of the onboard apparatus associated with said accelerometer;
calculating parameter values defining a geometric transformation for conversion of data between the reference frame of the carrier and the reference frame of the onboard apparatus using said stored inertial data and acceleration data.

The automatic harmonization method according to the invention may also present one or more of the features below, taken independently or according to any technically conceivable combination.

The calculation of parameter values is carried out by digitally solving a system of equations implementing a rotation matrix and a translation vector defining said geometric transformation for conversion of data.

The system of equations is obtained by expressing an acceleration vector of the onboard apparatus, provided by the accelerometer, in the reference frame of the mobile carrier and by expressing said acceleration vector of the onboard carrier in the reference frame of the mobile carrier from inertial data provided by the inertial unit in the reference frame of the mobile carrier.

The inertial data comprises an acceleration vector of the mobile carrier and a vector of angular rotational velocities of the mobile carrier in the reference frame of the mobile carrier.

The expression of an acceleration vector of the onboard apparatus provided by the accelerometer in the reference frame of the mobile carrier implements said rotation matrix.

The method is implemented for a plurality of flight maneuvers listed in a flight maneuver list, including a first subset of flight maneuvers with zero rotation angles and a second subset of flight maneuvers including angular accelerations of the mobile carrier.

According to another aspect, the invention relates to a computer program including code instructions which, when said program is executed by a computer, implement a method of automatically harmonizing position and/or orientation between apparatus on board a mobile carrier and a reference frame of the mobile carrier as briefly described above.

According to another aspect, the invention relates to a non-volatile information recording medium on which is recorded a computer program including code instructions which, when said program is executed by a computer, implement an automatic position and/or orientation harmonization method between apparatus on board a mobile carrier and a reference frame of the mobile carrier as briefly described above.

### BRIEF DESCRIPTION OF THE DRAWINGS

Other features and advantages of the invention will be apparent from the description given below, by way of indication and not in any way limiting, with reference to the appended figures, among which:

FIG. 1 schematically illustrates a system for automatically harmonizing the position and/or orientation between an apparatus on board a mobile carrier and a reference frame of the mobile carrier according to one embodiment of the invention;

FIG. 2 schematically illustrates an example of a reference frame of the mobile carrier and a reference frame of the onboard apparatus;

FIG. 3 is a flowchart of the main steps of a method for automatically harmonizing the position and/or orientation between an apparatus on board a mobile carrier and a reference frame of the mobile carrier according to one embodiment of the invention.

### DETAILED DESCRIPTION OF EMBODIMENTS

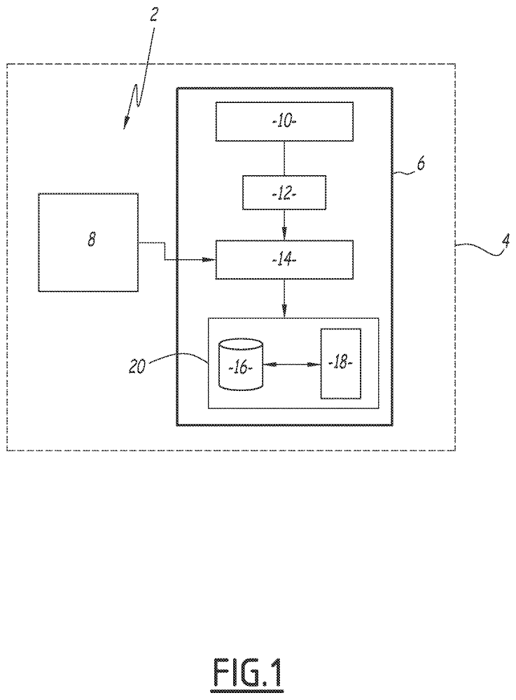

FIG. 1 schematically illustrates a system for automatic harmonization 2 of position and/or orientation between an onboard apparatus 6 on a mobile carrier 4 and a reference frame of the mobile carrier.

The mobile carrier 4 is for example an aircraft, such as a helicopter.

The onboard apparatus 6 is for example a radar system.

The mobile carrier 4 also includes an inertial measurement unit 8, which is a navigation instrument that provides, in a known manner, measurements of inertial data of the carrier, comprising acceleration and angular velocity data of the mobile carrier. This inertial data is provided in a three-dimensional reference frame related to the mobile carrier 4, in the form of acceleration vector and angular velocity vector of rotation of the mobile carrier. The inertial data obtained from the measurements provided by the inertial unit are used in a conventional way in navigation to estimate the orientation (roll, pitch and heading angles) of the mobile carrier, its linear speed and its relative position.

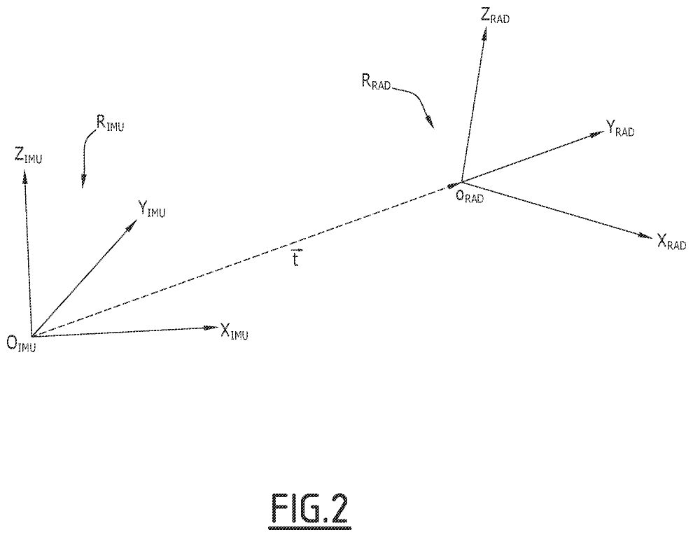

The three-dimensional reference frame related to the mobile carrier, also called hereafter IMU reference frame and noted R_{IMU}, illustrated in FIG. 2, includes an ° mu center and three orthogonal axes noted respectively X_{IMU}, Y_{IMU}, Z_{IMU}.

The onboard radar system 6 includes one or more antenna panels 10, each antenna panel having a radio signal transmission and reception center, hereinafter referred to as the antenna panel phase center, which is a reference point of the antenna panel 10. The or each antenna panel 10 is positioned on the mobile carrier 2.

For simplicity of explanation, only one antenna panel 10 is considered in the embodiment shown in FIG. 1.

The antenna panel 10 is mechanically coupled to a three-axis accelerometer 12, for example a MEMS-based accelerometer. Advantageously, such a component is available “off the shelf” and inexpensive.

When the radar system 6 includes multiple antenna panels, an accelerometer is mechanically coupled to each antenna panel.

The three-axis accelerometer 12 is a sensor for measuring the linear acceleration of its carrier, in this case the antenna panel 10, according to three predefined axes. The accelerometer 12 has an associated reference frame, referred to as the onboard apparatus reference frame, noted R_{RAD} in the schematic example in FIG. 2, and includes a center O_{RAD} and three orthogonal axes noted X_{RAD}, Y_{RAD}, Z_{RAD}, respectively.

The accelerometer 12 provides 3-axis acceleration data measurements in the form of A_{RAD} acceleration vectors in the onboard apparatus reference frame R_{RAD}.

Preferably, the accelerometer 12 is installed so that the O_{RAD} center of the associated reference frame is close, for example, to within a few centimeters, preferably less than 10 cm, of the phase center of the antenna panel 10. When the installation of the accelerometer 12 mechanically coupled to the antenna panel 10 is carried out during manufacturing, the positioning of the accelerometer 12 is carried out accurately and the response of the accelerometer can be calibrated during this installation phase so as to compensate for possible offset errors between the center of the reference frame O_{RAD} and the phase center of the antenna panel. Preferably, in addition, it is also intended to harmonize the sighting axis of the antenna panel 10 with the reference frame R_{RAD}. Harmonization of the radio electric sighting axis (boresight) consists of aligning the best axis of the radar beam, which is close to the normal of the antenna panel 10, and the corresponding axis of the accelerometer reference frame R_{RAD}. If this alignment is imperfect, the alignment deviation is estimated so that it can be compensated for. Conventional procedures for aligning the radar beam axis with the corresponding axis of the accelerometer reference frame are known.

The radar system 6, and more generally the onboard apparatus, comprises a reception unit 14 able to receive inertial data provided by the inertial unit 8, as well as acceleration data provided by the accelerometer 12, at successive measurement instants.

The inertial data provided by the inertial unit 8, as well as acceleration data provided by the accelerometer 12 and the associated measurement instants are provided to a programmable electronic device 20 and are stored in an electronic storage unit 16 of this device, able to store data.

The programmable electronic device 20 also includes a computing unit 18, such as a processor, able to execute executable code instructions when the programmable electronic device 20 is powered on. In particular, the processor 18 is configured to execute a computer program including executable code instructions to implement an automatic harmonization method according to the invention, as described below.

The computer program is, for example, stored on a non-volatile, computer-readable storage medium. By way of example, the computer-readable information medium is an optical disk, a magneto-optical disk, a ROM, a RAM, any type of non-volatile memory (for example, EPROM, EEPROM, FLASH, NVRAM), a magnetic card or an optical card.

According to one variation, the programmable device 20 is implemented as an ASIC or FPGA type programmed board.

FIG. 2, already mentioned, schematically illustrates the reference frame Rim linked to the inertial unit of the carrier, and reference frame R_{RAD} of the onboard apparatus. In the general case, a geometrical transformation, called a geometric transformation for conversion of data, including a translation and a rotation makes it possible to pass from one to the other of these reference frames. For example, it can be considered that the geometrical transformation allows to pass from the reference frame of the onboard apparatus R_{RAD} to the reference frame of the carrier Rim.

The translation is defined by a translation vector \vec{t} of coordinates (tₓ, t_{y}, t_{z}) in the reference frame R_{IMU}, which connects the O_{IMU} and θ_{RAD} centers of the reference frames.

The rotation is defined by a rotation matrix, composed of three elementary rotation matrices corresponding to three successive rotations of angles θₓ, θ_{y} and θ_{z} relative to the axes of the reference frame R_{IMU}, for example. The angles θₓ, θ_{y} and θ_{z} are representative of the orientation of the reference frame of the onboard apparatus, for example the antenna panel considered, relative to the reference frame of the mobile carrier.

The rotation matrix is expressed as follows:

$$R O T = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] \qquad [ MATH 1 ]$$

Where:

r₁₁=cos(θₓ)cos(θ_{y})

r₁₂=cos(θₓ)sin(θ_{y})sin(θ_{z})−sin(θₓ)cos(θ_{z})

r₁₃=cos(θₓ)sin(θ_{y})cos(θ_{z})+sin(θₓ)sin(θ_{z})

r₂₁=sin(θₓ)cos(θ_{y})

r₂₂=sin(θₓ)sin(θ_{y})sin(θ_{z})+cos(θₓ)cos(θ_{z})

r₂₃=sin(θₓ)sin(θ_{y})cos(θ_{z})−cos(θₓ)sin(θ_{z})

r₃₁=−sin(θ_{y})

r₃₂=cos(θ_{y})sin(θ_{z})

r₃₃=cos(θ_{y})cos(θ_{z})

Thus, the geometric transformation for conversion of data allowing to connect the two reference frames is defined by 6 parameters, which are respectively the coordinates tₓ, t_{y}, t_{z}) of the translation vector and the values of rotation angles θₓ, θ_{y} and θ_{z}.

The values of these parameters are obtained by solving a system of equations using inertial data provided by the inertial unit of the carrier and acceleration data provided by the accelerometer for at least two different flight orientations.

The system of equations is obtained by expressing an acceleration vector of the onboard apparatus, provided by the accelerometer, in the reference frame of the mobile carrier and expressing said acceleration vector of the onboard carrier in the reference frame of the mobile carrier from inertial data provided by the inertial unit in the reference frame of the mobile carrier, as explained in more detail below.

The acceleration vector of the onboard apparatus is expressed in the carrier reference frame R_{IMU} by the following equation, which implements inertial data provided by the inertial unit:

\vec{A}_{RAD/R}_{_{IMU}}=\vec{A}_{IMU}+\vec{ω}∧\vec{t}∧\vec{ω}+\vec{t}∧\vec{ω} [MATH2]

Where \vec{A}_{IMU} is the acceleration vector of the mobile carrier provided by the inertial unit and \vec{ω}, is the vector of rotational angular velocities of the mobile carrier provided by the inertial unit, \vec{t} is the translation vector between the centers of two reference frames, and \vec{ω} is the vector derived from the vector \vec{ω}, of rotational angular velocities. The vector \vec{ω} is determined, for example, by estimating a derivative of the vector \vec{ω} relative to time. The operator ∧ denotes the vector product in three-dimensional space.

On the other hand, the accelerometer provides an acceleration vector in the reference frame R_{RAD} of the onboard apparatus, which is transposable to the carrier reference frame R_{IMU} by applying the rotation matrix ROT defined by the formula [MATH 1] above, by the following expression:

\vec{A}_{RAD/R}_{_{IMU}}=ROT·\vec{A}_{RAD/R}_{_{RAD}} [MATH 3]

The harmonization method implements the solution of a system of equations with 6 unknowns, which are the parameters of the geometric transformation for conversion of data formed from the equality deduced from the formulas [MATH 2] and [MATH 3] above, for at least two measurements made by the inertial unit and the accelerometer for different flight orientations, performing different flight maneuvers.

The solution of the system of equations to obtain the values of the unknowns is implemented computationally and is not described in detail here because any computational method of solving a system of numerical equations is applicable. As a non-limiting example, the Gauss pivot method or a matrix inversion method can be used.

Preferably, several maneuvers corresponding to different flight orientations are implemented, so as to obtain, by the inertial unit and by the accelerometer, sufficiently independent measurements allowing the accuracy of the resolution of the implemented system of equations to be refined, and consequently, to refine the implemented harmonization.

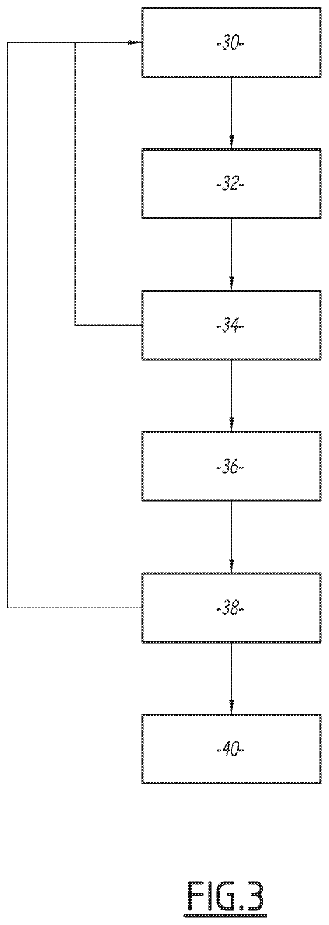

A method for automatic harmonization of position and/or orientation between apparatus on board a mobile carrier and a reference frame of said mobile carrier is illustrated schematically in FIG. 3.

The method includes a step 30 of commanding a flight maneuver from a predetermined list of flight maneuvers to be performed. The command step is either implemented by a pilot of the mobile carrier or implemented by an autopilot system in an automatic harmonization phase.

Preferably, the predetermined list of flight maneuvers is ordered. For example, when the mobile carrier is a helicopter, the list includes the following listed flight maneuvers M1 to M6:
M1: vertical acceleration;
M2: frontal acceleration;
M3: lateral acceleration;
M4: in-place heading rotation;
M5: pitch in place;
M6: roll in place.

Advantageously, the flight maneuvers listed are chosen to optimize the independence of the measurements performed.

Alternatively, the lateral acceleration maneuver M3 is replaced by a quasi-circular turn maneuver at constant speed, which makes it possible to obtain lateral acceleration information coupled with the actual rotation of the carrier.

The flight maneuver command step 30 is followed by a step 32 of receiving and storing inertial data provided by the inertial unit, and an associated time indication, for example a measurement instant.

The method also includes a step 34 of receiving and storing the acceleration data supplied by the accelerometer in question, and an associated time indication, for example a measurement instant.

The steps 32 and 34 are preferably performed simultaneously to report the same flight orientation following a controlled maneuver.

The steps 30-34 are repeated, in one embodiment, for all listed flight maneuvers M1 to M6.

Alternatively, the steps 30-34 are repeated for a subset of the maneuvers in the predetermined list of flight maneuvers, for example, for maneuvers M1 to M3 with zero rotation angles, thereby removing the contribution of unknowns related to the translation vector \vec{t} and components related to the actual rotation of the aircraft.

The steps 32, 34 are followed by a step 36 of computing parameter values of the geometric transformation between reference frames, based on the solution of the system of equations described above.

In the case where a subset of flight maneuvers has been performed, a subset of the parameter values is obtained, for example the rotation angle values Ox, Oy and Oz.

The step 36 is followed by a step 38 of storing the calculated transformation parameter values.

The step 38 is optionally followed by a return to step 30 to perform additional flight maneuvers from the predetermined list of flight maneuvers, allowing the calculated parameter values to be refined.

For example, the steps 30 to 34 are repeated for a second subset of the maneuvers in the predetermined list of flight maneuvers, for example, maneuvers M4 to M6 including angular accelerations according to the 3 axes of rotation of the mobile carrier. After the acquisition and storage of inertial data and acceleration data from the accelerometer for flight maneuvers, the steps 36 and 38 are also repeated.

Finally, the stored values of the parameters of the geometric transformation between reference frames are used during step 40.

The utilization comprises for example, the computational compensation of the movements of the mobile carrier in the calculation of the direction of the sighting axis of the considered antenna panel of the radar system, and the correction in the display of the data from the radar system relative to the mobile carrier.

When the radar system has multiple antenna panels, each having an accelerometer mechanically coupled to the panel, steps 34-38 are performed for each antenna panel.

The step 40 implements, in certain cases, the geometric transformation parameters calculated for each antennae panel. For example, in the case of a multiple antenna panel radar system, the position and orientation information of multiple antenna panels provided automatically by the method of the invention is used to determine the geometric configuration of the radar on the carrier, without requiring manual or software identification.

In another embodiment, the values of the parameters of the geometric transformation for conversion of data, and hence the position and orientation of the onboard apparatus, for example, of each antenna panel of the radar system, are refined during flight. Advantageously, this makes it possible to compensate for possible deformations undergone by the carrier or by the onboard apparatus during use.

In a sub-optimal variant, only the values of rotation angles defining the orientation of the onboard apparatus, for example of each antenna panel of the radar system, are calculated.

The invention has been described above in its implementation using a three-axis accelerometer for each piece of onboard apparatus for which position and/or orientation harmonization is sought. In a sub-optimal variant, a single or dual axis accelerometer is used.

In another variant, in addition to the mechanical coupling of accelerometers to the onboard apparatus, it is planned to add a gyrometer coupling, thus making it possible to realize an inertial unit per onboard apparatus, and thus to refine the harmonization results, at a higher cost.

The invention has been described above in the particular case where the onboard apparatus is a radar system, but it also applies to other onboard apparatus, for example optronic, sonar or acoustic sensors, without being limited to these apparatus.

Advantageously, the invention makes it possible to automatically obtain parameters defining the position and/or orientation of an onboard apparatus on a mobile carrier in a reference frame of said mobile carrier, with a limited number of flight maneuvers, and without requiring a precise installation of the onboard apparatus.

Advantageously, the replacement of onboard apparatus, for example certain antenna panels for a radar system, does not require manual calibration.

1. A system for automatically harmonizing the position or orientation between an apparatus on board a mobile carrier and a reference frame of said mobile carrier, said mobile carrier being equipped with an inertial unit able to provide measurements of acceleration and angular velocity of rotation of said mobile carrier in said reference frame, comprising:
at least one accelerometer mechanically coupled to the onboard apparatus, and providing acceleration measurements in a reference frame referred to as the associated onboard apparatus,
a reception unit configured to receive measurements provided by said inertial unit and measurements provided by the accelerometer,
a computing unit configured to calculate values of parameters defining a geometric transformation for conversion of data between the reference frame of the carrier and the reference frame of the onboard apparatus, from said measurements, carried out for at least two different flight orientations, by said inertial unit and by said accelerometer.

2. The system according to claim 1, wherein said accelerometer is an accelerometer able to provide acceleration measurements along three spatial axes.

3. The system according claim 1, wherein said mobile carrier is an aircraft, said onboard apparatus is a radar system including at least one antenna panel, the or each antenna panel having an associated phase center, and including an accelerometer mechanically coupled to the antenna panel and having a reference frame centered on said phase center.

4. The system according to claim 1, wherein the geometric transformation for conversion of data comprises a rotation and a translation, the rotation being defined by three rotation angles and the translation being defined by a translation vector.

5. The system according to claim 4, wherein the calculation of parameter values is performed by digitally solving a system of equations implementing a rotation matrix defining said rotation and said translation vector.

6. A method for automatically harmonizing the position or orientation between an apparatus on board a mobile carrier and a reference frame of said mobile carrier, implemented by a harmonization system in accordance with claim 1, and including the steps, for at least two flight maneuvers corresponding to two different flight orientations of:
receiving and storing inertial data obtained from measurements provided by the inertial unit in a reference frame of the inertial unit;
receiving and storing acceleration data obtained from measurements provided by an accelerometer in a reference frame of the onboard apparatus associated with said accelerometer;
calculating parameters values defining a geometric transformation for conversion of data between the reference frame of the carrier and the reference frame of the onboard apparatus using said stored inertial data and acceleration data.

7. The method according to claim 6, wherein the calculation of parameter values is performed by numerically solving a system of equations implementing a rotation matrix and a translation vector defining said geometric transformation for conversion of data.

8. The method according to claim 7, wherein said system of equations is obtained by expressing an acceleration vector of the onboard apparatus, provided by the accelerometer, in the reference frame of the mobile carrier and by expressing said acceleration vector of the onboard carrier in the reference frame of the mobile carrier from inertial data provided by the inertial unit in the reference frame of the mobile carrier.

9. The method according to claim 8, wherein the inertial data comprises an acceleration vector of the mobile carrier and a vector of rotational angular velocities of the mobile carrier in the reference frame of the mobile carrier.

10. The method according to claim 8, wherein expressing an acceleration vector of the onboard apparatus provided by the accelerometer in the reference frame of the mobile carrier implements said rotation matrix.

11. The method according to claim 6, implemented for a plurality of flight maneuvers listed in a flight maneuver list, including a first subset of zero angle of rotation flight maneuvers and a second subset of flight maneuvers including angular accelerations of the mobile carrier.

12. A computer program including software instructions which, when executed by a computer, implements a method for automatic harmonization of position or orientation between an apparatus carried on a mobile carrier and a reference frame of said mobile carrier according to claim 1.
